(19) United States
(12) Patent Application Publication
(10) Pub. No.: US 2026/0219963 A1
(43) Pub. Date: Jul. 30, 2026

(54) Persisting Mutex Lock Data To Enhance Failover Handling By Storage Controllers

(71) Applicant: NetApp, Inc., San Jose, CA (US)

(72) Inventors: Ajeet Kumar, Bangalore (IN); Dipti Anil Kothari, Bangalore (IN)

(73) Assignee: NetApp, Inc., San Jose, CA (US)

(21) Appl. No.: 19/184,420

(22) Filed: Apr. 21, 2025

Related U.S. Application Data
(60) Provisional application No. 63/749,444, filed on Jan. 24, 2025.

(51) Int. Cl. G06F 9/52; H04L 67/1097

(52) U.S. Cl. CPC G06F 9/526; H04L 67/1097

(57) ABSTRACT

Improved failover handling by persisting lease lock data to storage. Storage controllers of a data storage system handle client I/O requests for files or portions of files in a storage aggregate of the system. The controllers obtain lease locks on behalf of clients for the I/O requests and record lock data in the storage aggregate. If a first controller of the system fails over to a second controller, a grace period is triggered. The second controller gets the lock data from storage and processes an I/O request received from a client during the grace period. From the data, the second controller determines if the first storage controller held the lock corresponding to the I/O request. If the first storage controller held the lock, the second controller immediately executes the request. Where the first storage controller did not hold the lock, the second controller obtains the lock to execute the request.

### RELATED APPLICATIONS

This application hereby claims the benefit and priority to U.S. Provisional Patent Application No. 63/749,444, titled “PERSISTING MUTEX LOCK DATA TO ENHANCE FAILOVER HANDLING BY STORAGE CONTROLLERS,” filed January 24, 2025, which is hereby incorporated by reference in its entirety.

### TECHNICAL FIELD

Aspects of the disclosure are related to the field of data storage solutions and in particular, to storage controller operation.

### BACKGROUND

The Network File System (NFS) protocol is a distributed file system protocol that operates on a client/server basis. The NFS protocol allows clients (e.g., Linux or Unix clients) to access and manage files and directories over a network. One of the features in the fourth version of NFS (NFSv4) is a file locking service is integrated into NFSv4 that uses mutually exclusive locks to prevent more than one client from accessing a given file at a time. The file locking service in NFSv4 uses a locking mechanism called lease-based locking in which an NFS server assigns leases for granted locks that award ownership of the lock to the holder of the lease. The lease defines the time period in which a client is granted a lock. A client may renew the lease with the NFS server to preserve the lock state and continue using the lease lock. As such, the locks in NFSv4 provide time-bounded control, which can be extended, over a file state. If the client fails to renew a lease, the NFS server releases the lock and updates lock metadata accordingly allowing other clients to lock the file.

Methods and systems for improved failover handling by persisting lease lock data to storage of a data storage system such that when a storage controller of the system fails over to a second storage controller of the system, the second storage controller can begin processing I/O without unnecessary delays caused by a fixed lock reclamation grace period.

In various implementations, a first storage controller of the data storage system receives I/O requests from clients that correspond to files or portions of files held in a storage aggregate of the data storage system. The first storage controller obtains lease locks on behalf of clients to ensure mutually exclusive access to files or portions of files and persists lease lock data to the storage aggregate that reflects which lease locks were taken on behalf of which clients. The first storage controller then fails over to a second storage controller of the data storage system (i.e., the second storage controller takes the place of the first storage controller) and a lock reclamation grace period is triggered. In response, the second storage controller obtains the lease lock data from the storage aggregate. The second controller receives an I/O request from a client during the ongoing grace period. The second storage controller reads the lease lock data to determine where I/O requests can immediately be executed without creating a risk of collision.

In one embodiment, the second storage controller queries the lease lock data to determine whether the first storage controller held, at the time of failure, the lease lock corresponding to the I/O request received at the second storage controller. Where the second storage controller determines that the relevant lease lock was held by the now failed first storage controller, the second storage controller can immediately proceed with the I/O request without fear of collision. The risk of collision is effectively eliminated here because the previous holder of the lease lock has failed and is no longer executing I/O requests. Alternatively, where the second storage controller determines, from the persisted lease lock data, that the relevant lock was not held by the first storage controller, the second storage controller must obtain the lock through traditional means (e.g., request the lock from a distributed lock service on the second storage controller).

This Summary introduces a selection of concepts in a simplified form that are further described below. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification`s, and equivalents.

FIG. 1A illustrates an operational environment in accordance with an implementation.

FIG. 1B illustrates another operational environment in accordance with an implementation.

FIG. 2 illustrates a method in accordance with an implementation.

FIG. 3 illustrates an operational sequence in accordance with an implementation.

FIG. 4 illustrates a further operational sequence in accordance with an implementation.

FIG. 5 illustrates a computing device used in accordance with several implementations.

### DETAILED DESCRIPTION

Disclosed herein are methods and systems for improved failover handling by persisting lease lock data to storage of a data storage system. In order to maintain file access and ensure data consistency, NFS lease locks maintain a persistent state on both the client and server. State IDs and sequence IDs can be used to track and manage the stateful interactions between the client and server. The state information includes information about which files are locked, the duration of the lock, and the type of locks (e.g., read, write, etc.). As long as the interaction with the file is active, the locks can be automatically renewed. However, after a period of inactivity the client may need to actively renew the lease, or the server will release the lock. After a server reboot or failure, a grace period is provided to allow clients to reclaim their locks. During this grace period new locks are not granted to other clients.

In some storage system clusters implemented using NFS protocols, clients access storage resources through virtual interfaces known as logical interfaces (LIF). A LIF exists at the network layer and represents an endpoint for communication between clients and the storage system. LIFs move dynamically (i.e., migrate) between physical network ports or nodes of a storage cluster to support high availability, load balancing, maintenance, or during a failover event. When a LIF migrates from one port or node to another, state information for clients associated with the first port or node also migrates.

However, in some scenarios (e.g., aggregate relocation, LIF migration to different node, takeover, failover, etc.), LIF migration may result in lost state information regarding which clients hold which locks. In other words, it is not known which locks the original host of the LIF took on behalf of which clients. The absence of lock state information necessitates a grace period allowing clients to reclaim their previous locks. Traditionally, the NFS server pauses input/output (I/O) operations and does not allow new lock acquisition during the grace period, allowing clients to re-establish (i.e., reclaim) their locks. This restrictive grace period results in delays before normal operations can resume, often resulting in delayed operations from the perspective of clients.

The grace period must be configured to be long enough to allow for a theoretical maximum number of locks to be reclaimed while not being so short as to risk corruption from another client writing to the file that was previously locked. The grace period has a fixed length and is commonly configured to favor avoiding corruption over efficiency. Unfortunately, while such a grace period is sufficient to allow for a large number of lease locks to be reclaimed, the period represents significant and unnecessary delay where few or no locks need reclamation. As a result, client I/O operations are similarly delayed.

In contrast, various embodiments of the present invention provide techniques for mitigating delay caused by the fixed lock-reclamation grace period. To reduce or eliminate the delay caused by the grace period, a storage controller or other computing device implementing an NFSv4 system persists lease lock data to a storage aggregate such that if the storage controller fails over to a second storage controller, a second storage controller of the system may be able to process I/O requests without unnecessary delays caused by a fixed lock reclamation grace period.

In some embodiments, a first storage controller of the data storage system receives I/O requests from clients that correspond to files or portions of files held in a storage aggregate of the data storage system. To process a given I/O request received from one of the clients, the first storage controller obtains a lease lock on behalf of the client for the file or portion of a file corresponding to the I/O request. As a result, the client for which the first storage controller holds the lease lock is granted exclusive access to the file or portion of file. In some embodiments, a different device than the first or second storage controller implements an NFS server. In such embodiments, the device implementing the NFS server may grant lease locks to the first and second storage controllers.

Having taken the lease lock on behalf of a client, the first storage controller persists lease lock data to the storage aggregate that reflects which lease locks were taken for which clients. The first storage controller then fails over to a second storage controller of the data storage system (i.e., the second storage controller takes the place of the first storage controller), triggering a lock reclamation grace period. In response, the second storage controller obtains the lease lock data from the storage aggregate. The second controller receives an I/O request from a client during the grace period and reads the lease lock data to determine how to proceed.

Where the necessary lease lock for the I/O request was held by the first storage controller at the time of failure or other migration, the second storage controller can immediately execute the I/O request without a risk of collision (i.e., two users attempt to write to the same file at the same time resulting in inconsistent versions of a file). The second storage controller can proceed without risk of collision because the previous holder of the lock (the first storage controller) has failed and is no longer actively executing I/O requests.

Where the necessary lease lock for the I/O request was not held by the first storage controller at the time of failure or other migration, the second storage controller must obtain the lock through traditional means, such as requesting the lock from a distributed lock service.

In some embodiments, the failover includes a migration of a logical interface (LIF) from the first storage controller to the second storage controller. In such embodiments, clients interact with the first storage controller via the LIF associated with the first storage controller. Where the LIF then migrates from the first storage controller to a second storage controller, client I/O requests that had been directed to and processed by the first storage controller are directed to and processed by the second storage controller. Where the second storage controller receives an I/O request after the failover has occurred, the I/O request is received via the migrated LIF. In some embodiments, the second storage controller obtains the lease lock data from the storage aggregate in response to a LIF migration.

In some embodiments, the second storage controller receives an I/O request from a second client and determines from the lease lock data that the lease lock corresponding to the I/O request was held by another storage node on behalf of another client. As a result, the second storage controller does not immediately execute the I/O request. The I/O request is not immediately executed because the risk of collision has not been eliminated here, as the previous (and current) holder of the lease lock has not failed and continues to process I/O requests. In some such embodiments, the lack of execution for the I/O request triggers the scheduling of another attempt to obtain the lease lock associated with the I/O request and to execute the I/O request.

In some embodiments, determining that the first storage controller had not given taken the lease lock on behalf of another client for the file or portion of the file to any other client based on the lease lock data includes searching the lease lock data for an indication that the first storage controller had not taken the lease lock on behalf of any other client. In some embodiments, searching the lease lock data for an indication that the first storage controller had not taken the lease lock for another client includes identifying the file or portion of a file and searching the lease lock data for another client for which the lease lock corresponding to the identified file or portion of the file was granted.

In some embodiments, the storage controllers of the data storage system, including the first storage controller and the second storage controller, provide a network file system (NFS) to clients, including the client and the second client. In such embodiments, the lease lock is an NFS lock. In some such embodiments, the lease lock, comprising an NFS lock, is a temporary, renewable lock on at least a portion of a file.

In some embodiments, persisting lease lock data to the storage aggregate includes persisting operational data of the first storage controller, or of any other storage controller, to a partition of the storage aggregate reserved for storing metadata of the data storage system. In some cases, the partition of the storage aggregate may be reserved specifically for metadata associated with a particular storage controller of the data storage system.

Various embodiments of the present technology provide for a wide range of technical effects, advantages, and/or improvements to computing systems and components. For example, various embodiments may include one or more of the following technical effects, advantages, and/or improvements: 1) non-routine and unconventional implementation of improved failover processes; 2) non-routine and unconventional implementation techniques for persisting lease lock data to storage; 3) non-routine and unconventional algorithms and storage configuration that provides the ability to reduce or eliminate the effect of a grace period provided to clients for lock reclamation; 4) non-routine and unique operation of a storage system that allows for the use of persisted lock information for lock ownership allocation; 5) new and improved processes for lock validation that minimizes (or significantly reduces) client I/O operations execution after a LIF migration; 6) non-routine and unconventional techniques for selective lock reclamation; 7) modification to storage operations that allows for new clients to proceed with I/O operations when a requested lock does not conflict with existing locks; 8) integration of a framework for managing lock records; and 9) non-routine and unconventional configuration and operation of a storage system that optimizes (or improves) performance by minimizing lock reclamation grace periods.

While the descriptions and examples given to describe techniques herein are directed to a system using the fourth version of the Network File System (NFSv4), it will be appreciated that the benefits of the disclosed technology can be applied to environments using the Lustre File System, the General Parallel File System, or to environments using any other file system or protocol that implements a grace period allowing for the reclamation of synchronization locks for which state information was lost.

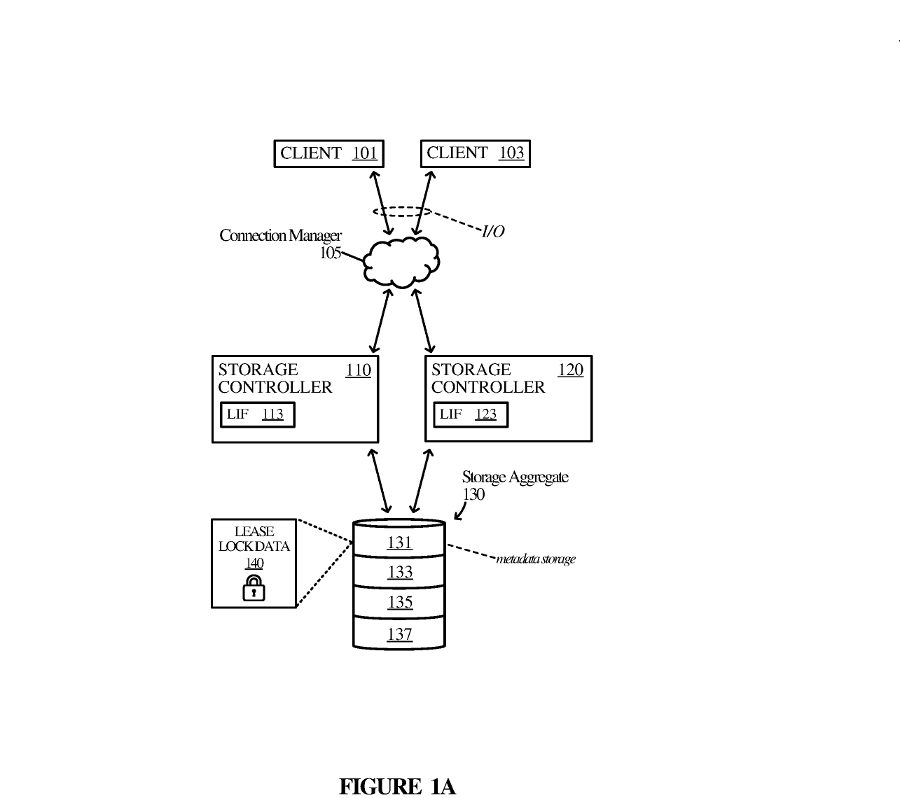

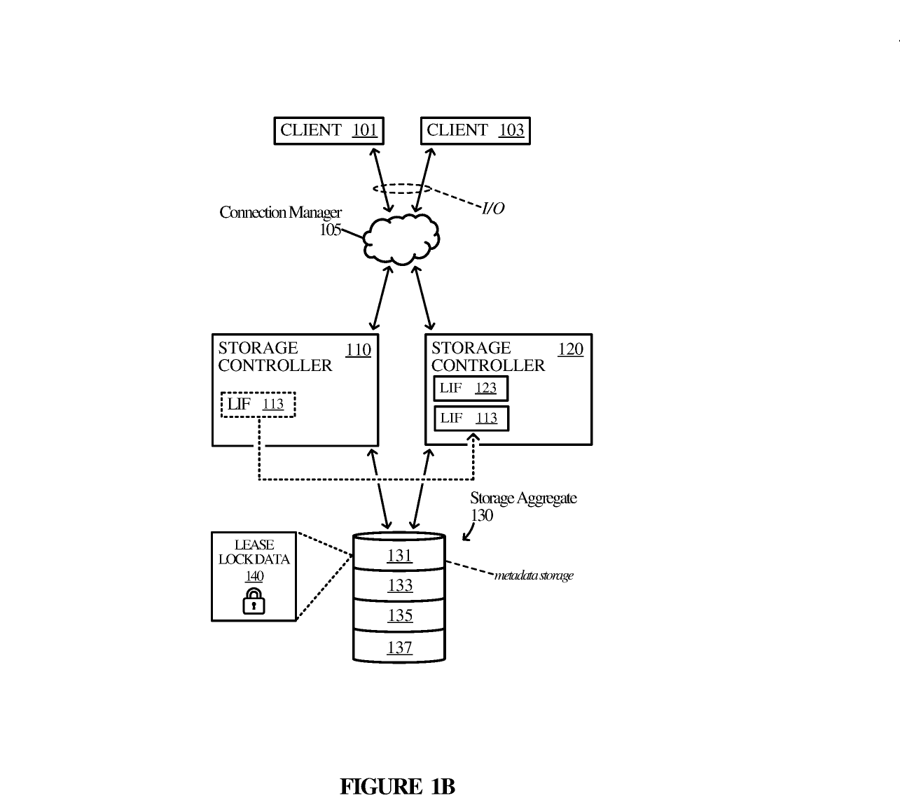

FIG. 1A illustrates operational environment 100a in accordance with an embodiment. Operational environment 100a includes client 101, client 103, connection manager 105, storage controller 110, storage controller 120, and, and storage aggregate 130. Storage controller 110 includes logical interface 113, hereinafter LIF 113. Storage controller 120 includes logical interface 123, hereinafter LIF 123. Storage aggregate 130 further includes storage 131, storage 133, storage 135, and storage 137. Storage 131 further includes lease lock data 140.

Operational environment 100 is generally representative of an operational environment in which storage controller 110 and storage controller 120 operate to process I/O requests submitted by client 101 and client 103 and to facilitate access to storage aggregate 130. While not illustrated in FIG. 1A, the storage controllers can be communicably coupled via a cluster interconnect enabling high speed communication and data transfer between the storage nodes. In other embodiments, operational environment 100 may include any number of clients and/or any number of storage controllers.

Client 101 and client 103 are each representative of a client of a data storage system that generates I/O requests to be processed by storage controller 110, storage controller 120, or another storage controller of the data storage system. Client 101 and client 103 may each be a human user, an application, a software process, or any other source of I/O requests to be processed by the data storage system.

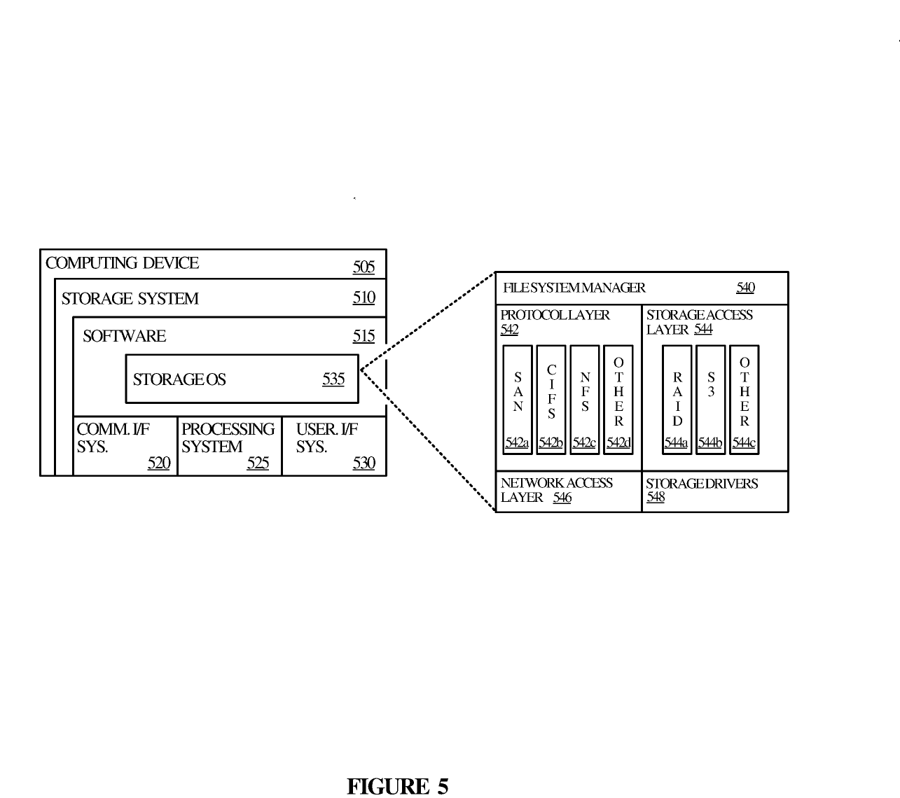

Connection manager 105 is generally representative of a manager for directing I/O requests to one or more storage controllers such as storage controller 110 and storage controller 120. Connection manager 105 may be implemented via an administrative node of operational environment 100. Connection manager 105 may be implemented by a physical computing device, a virtual computing device, or a combination thereof. An example of such computing devices are given by computing device 505 of FIG. 5.

In the embodiment illustrated in FIGS. 1A and 1B, either or both of storage controller 110 and storage controller 120 implement an NFS server. The NFS server may be executable instructions that, when executed by a processing device of either or both of storage controller 110 and storage controller 120, direct either or both of storage controller 110 and storage controller 120 to carry out the processes as described herein. In some other embodiments, another element may implement an NFS server, in which case storage controller 110 and storage controller 120 interact with the other element in order to carry out storage processes.

Storage controller 110 is generally representative of a storage controller in a data storage system responsible for managing data flow between the storage devices (e.g., storage aggregate 130) and clients (e.g., client 101 and client 103). Storage controller 110 implements a storage operating system, described in detail below, in order to manage data flow between storage devise and clients. Storage controller 110 is communicatively coupled with both connection manager 105 and storage aggregate 130. Storage controller 120 is generally representative of a storage controller in a data storage system responsible for managing data flow between the storage devices (e.g., storage aggregate 130) and clients (e.g., client 101 and client 103). Storage controller 120 implements a storage operating system, described in detail below, in order to manage data flow between storage devise and clients. Storage controller 120 is communicatively coupled with both connection manager 105 and storage aggregate 130.

In some embodiments, storage controller 110 and storage controller 120 may be considered together as a high-availability (HA) pair of controllers. An HA pair may be configured in an active/passive configuration. In this configuration, the HA pair includes a controller that receives and processes I/O requests, and a second redundant controller (e.g., storage controller 120) that acts as a backup to the controller. In such embodiments, where storage controller 110 fails, storage controller 120 takes the place of the failed controller and becomes the active controller of the HA pair for processing I/O requests and interfacing with storage aggregate 130.

LIF 113 and LIF 123 are each representative of a virtual network endpoint in a data storage system that provides clients with access to data over protocols like NFS, Server Message Block (SMB), or Internet Small Computer Systems Interface (iSCSI). LIF 113 and LIF 123 are each associated with an IP address and can dynamically migrate between network ports or nodes (i.e., storage controllers) within a data storage cluster to ensure high availability, load balancing, seamless client access, and the like.

Storage aggregate 130 is generally representative of non-volatile data storage resources logically grouped together. In some cases, these storage resources may be a collection of disks (or partitions) arranged into one or more RAID groups. Storage aggregate 130 may be implemented with any number of hard disk drives (HDDs), solid-state drives (SSDs), flash memory, any other sufficient non-volatile storage medium, or a combination thereof. Storage aggregate 130 includes storage 131, storage 133, storage 135, and storage 137. Each of storage 131, storage 133, storage 135, and storage 137 are representative of some portion of storage aggregate 130 and may correspond to partitions of storage aggregate 130.

Storage 131 includes lease lock data 140. Lease lock data 140 is representative of data that indicates which lease locks have been given to clients. Lease lock data 140 may be a a table or other data structure sufficient to communicate various ownership details about lease locks. For example, lease lock data 140 may be a table that includes information for each individual lease lock that indicates a corresponding client or client ID, a current owner of the lock, a file or byte range corresponding to the lock, a state or state ID, and expiration information. In some cases, a byte range lock may correspond to multiple files, while in other cases a byte range lock may correspond to a portion of a file. In some embodiments, storage 131, in which lease lock data 140 is stored, represents a partition of storage aggregate 130 that is reserved for metadata of the data storage system.

FIG. 1B illustrates another operational environment 100b in accordance with an embodiment, hereinafter referred to as environment 100b. Environment 100b is substantively the same as and includes the same elements as operational environment 100a expect that environment 100b further illustrates an example operational scenario in accordance with an embodiment.

In particular, environment 100b illustrates an example operational scenario in which a migration of LIF 113 has occurred from storage controller 110 to storage controller 120. In some cases, the migration of LIF 113 from storage controller 110 to storage controller 120 occurs as part of a failover process. In some other cases, the migration of LIF 113 may be the result of failover process (e.g., node or hardware failure) or may be the result of load balancing, system maintenance, or other such procedures in the data storage system.

As shown in environment 100b, LIF 113 is migrated from storage controller 110 to storage controller 120. As a result, storage controller 120 now includes both LIF 113 and LIF 123, each of which various clients (e.g., client 101 and client 103) can use to communicate with storage controller 120. Here, the migration of LIF 113 may be the result of a failure of storage controller 110 or of some other failure associated with storage controller 110.

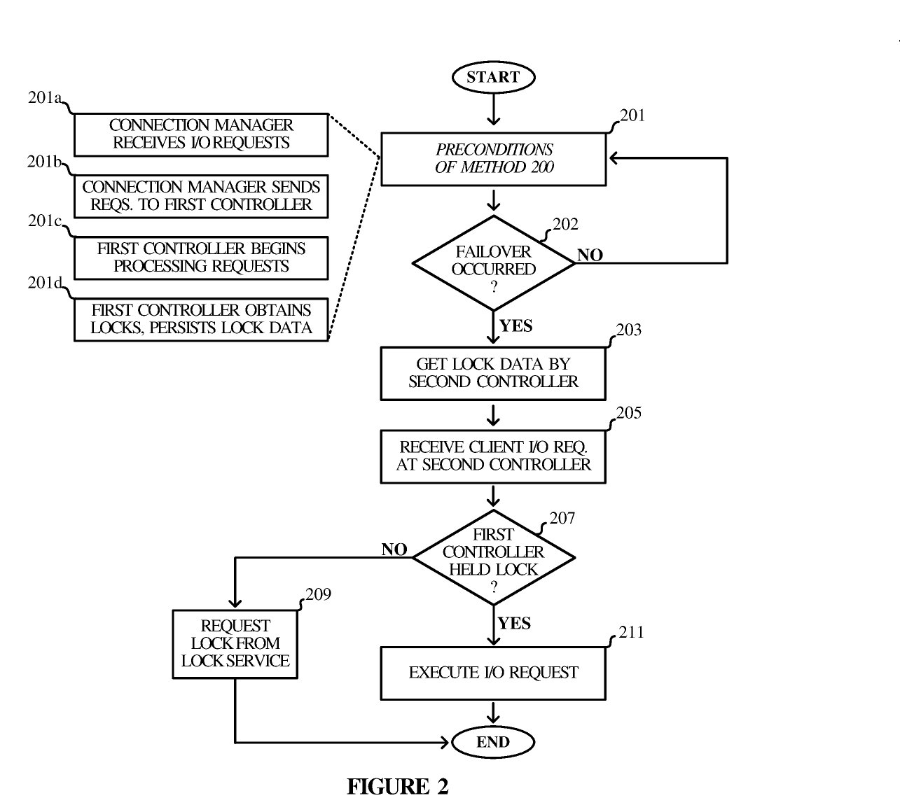

FIG. 2 illustrates method 200 in accordance with an embodiment. Method 200 is representative of mutually exclusive lock procedure and may be implemented in program instructions in the context of the software and/or firmware elements of storage controller 110 and storage controller 120, each of FIG. 1, respectively. The program instructions (e.g., storage operating system 535 of FIG. 5), when executed by one or more processing devices of one or more computing systems (e.g., computing device 505 in FIG. 5), direct the one or more computing systems to operate as follows, referring parenthetically to the steps in FIG. 2, and in the singular to a computing device for the sake of clarity. Further, method 200 may implemented by processing system 525 of FIG. 5 executing storage operating system 535 of FIG. 5, and in particular, by processing system 525 executing NFS 542c of FIG. 5.

To begin, several preconditions occur that provide the conditions in which method 200 may be implemented (step 201). A connection manager (e.g., connection manager 105 of FIG. 1) receives multiple I/O requests from data storage clients (e.g., client 101 and client 103) (step 201a). The connection manager sends the I/O requests to a first storage controller (e.g., storage controller 110 of FIG. 1) (step 201b). The first storage controller begins processing an I/O request provided by the connection manager (step 201b). During operation, the first storage controller requests, and is given, lease locks corresponding to I/O requests being processed (step 201c). A lease lock may be requested by the storage controller to prevent race conditions where multiple users attempt to read, write, or modify the same file or region of a file concurrently. For instance, a write lock may prevent other users from reading or writing to a file or region of a file until the lock is released. A read lock may allow multiple readers for a particular file or region of a file but may prevent writing to that file for those not holding the corresponding lock. In an example, a user may seek to write to a particular file. The user interacts with the storage controller, which grants the lease lock for the particular file. While the lock is held, the user may read and write to the file without concern that another user may write to the file and cause inconsistency in different versions of the file. Once the user finishes the write operation, the lock can be released and another user can now write to the file without data integrity problems. The lease locks correspond to the file or portion of a file associated with the I/O request. Upon being given a lease lock, the first storage controller persists lease lock data to a storage aggregate (storage aggregate 130 of FIG. 1) (step 201d). Here, a second storage controller determines whether or not a failover associated with the first storage controller has occurred (step 202). To determine whether or not the failover associated with the first storage controller has occurred, the second storage controller may query the first storage controller for acknowledgments in some embodiments. In some other embodiments, another device may monitors the first storage node and, in response to detecting a failover in the first storage controller, informs the second controller of the failover.

In some embodiments, the second storage controller determines that the first storage controller experienced a handover as a result of upgrades or maintenance. A handover is similar to a failover (i.e., the second controller assumes the responsibilities and resources of the first controller) except that the handover is typically an intended event as opposed to the unexpected nature of a failover. During a handover event, storage systems commonly incorporate mechanisms that ensure that state information for locks held by the first storage controller is recorded and made available to the second storage controller, reducing the delays associated with lock recovery. In some scenarios, however, a handover may occur before the lock state information can be recorded. In such cases, the techniques disclosed herein can be used to mitigate the delays caused by the loss of the lock state information. Many examples herein describe the disclosed techniques with regard to unplanned failover events but may also be considered with respect to handover events where lock state information (i.e., lease lock data) has not been sufficiently recorded.

If a failover has not occurred, the first and second storage controllers operate normally. However, if the second storage controller detects the failure of the first storage controller, the second storage controller begins a failover process in order to take the place of the failed first storage controller. Where a failover has occurred, a lock reclamation grace period is started. During the lock reclamation grace period, step 203, step 205, step 207, step 209, and step 211 are carried out.

In response to the failover, which occurs from the first storage controller to the second storage controller, the second storage controller obtains lease lock data that had been persisted to storage by the first storage controller (step 203) in order to process I/O requests. In some embodiments, the lease lock data is located in a dedicated storage region of a drive that both the first storage controller and second storage controller have access to. In some cases, the dedicated region of the drive may be exclusively reserved for metadata storage. In some cases, the dedicated region of the drive may be exclusively reserved for lease lock data storage. In such cases, the second storage controller retrieves the lease lock data from one of these locations. The second storage controller receives an I/O request from a client and proceeds with processing the I/O request (step 205). In some cases, the second storage controller may receive the I/O request before obtaining the lease lock data. In some embodiments, the second storage controller maintains a cache of I/O requests that correspond to I/O requests being processed by the first storage controller. The first storage controller loads a request into the cache and informs the second storage controller, which responsively loads a copy of the request into a cache at the second storage controller. When the first storage controller executes the request, the first storage controller informs the second storage controller, which removes the request from the cache at the second storage controller. Where the first storage controller fails, the second storage controller may be left with a cache of requests associated with the first storage controller that have not yet been executed. In some embodiments, the second storage controller first processes the I/O requests that remain in the cache before receiving and processing additional I/O requests.

The second storage controller then determines whether the first storage controller held the lock associated with the I/O request received at the second storage controller (step 207). For instance, this may occur where an I/O request being processed by the first storage controller corresponds to the same lock as the I/O request received at the second storage controller. In such a scenario, the second storage controller can immediately execute the I/O request without concern for collision that might result in inconsistent data (step 211). In particular, by determining that the previous holder of the required lock was the first storage controller (which failed), the second storage controller can operate on the file or region corresponding to the lock while avoiding collisions because the “current” holder of the lock failed before releasing the lock and is thus not operating on the file or region.

In contrast, where the first controller did not hold the lock associated with the I/O request received at the second storage controller, the second storage controller must request the lock (step 209). In some embodiments, the second storage controller requests the lock from a distributed lock service running on the second node. Should the distributed lock service indicate the lock is not available, the second storage node will not be able to immediately execute the I/O request.

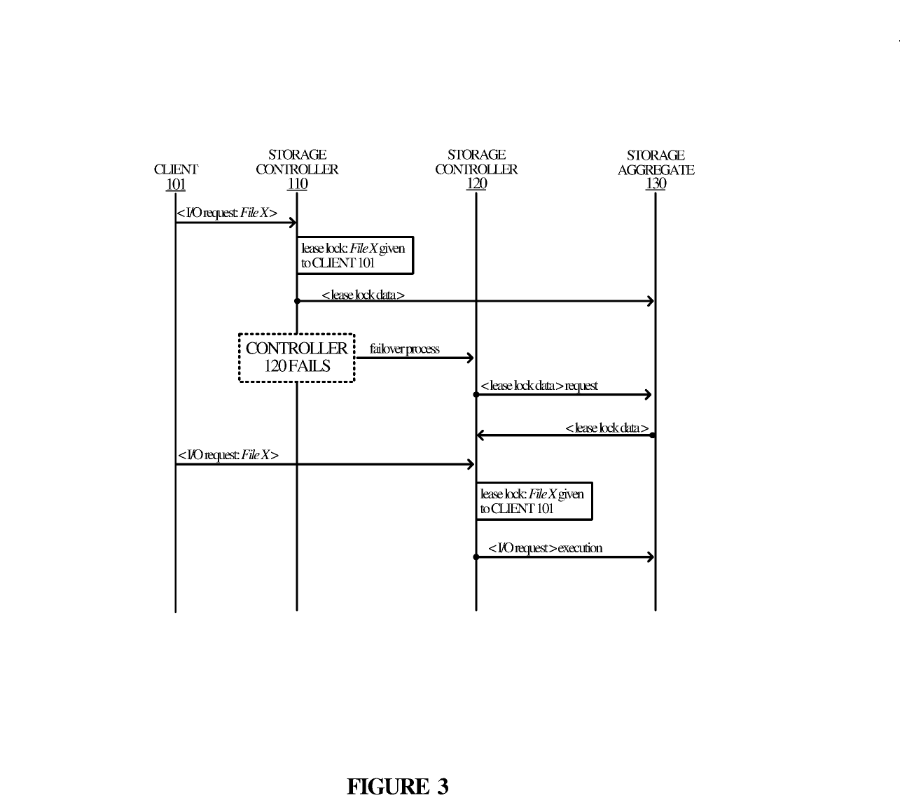

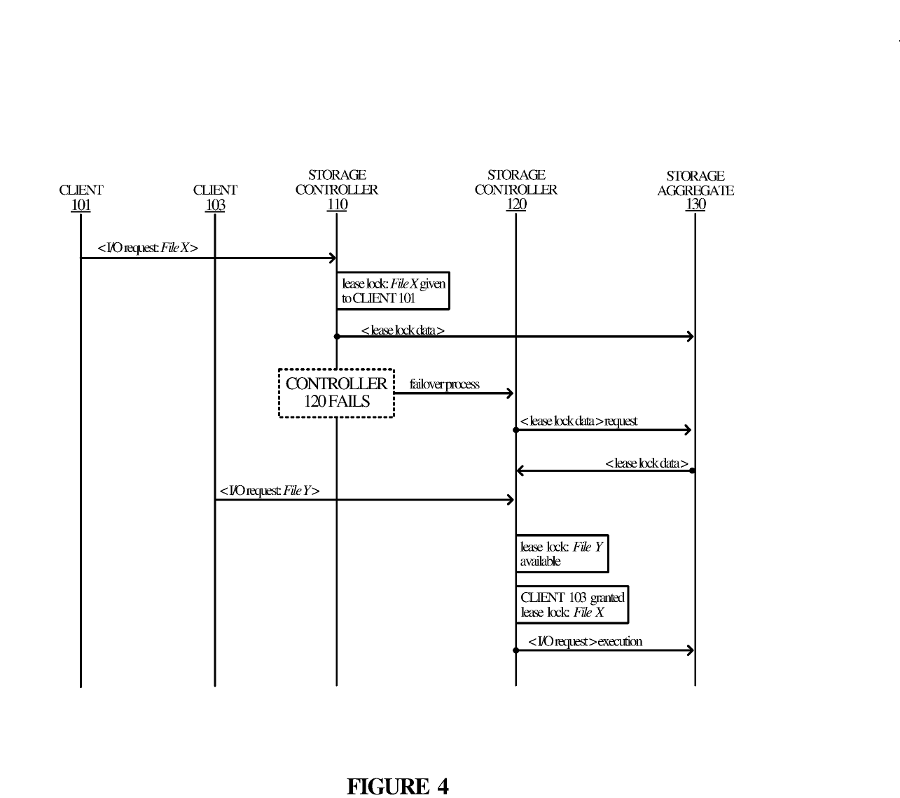

FIGS. 3-4 both illustrate operational sequences that show details for example implementations of the techniques described herein, an example of which is given by method 200 of FIG. 2. FIG. 3 and FIG. 4 are generally similar except that in FIG. 3, the same client (client 101) that had granted the lease lock by storage controller 110 requests the lease lock from storage controller 120, while FIG. 4 includes two different clients operating with respect to two different files that correspond to two different lease locks. The benefits of the techniques described herein are shown in both FIGS. 3 and 4, though with respect to the different operational sequences illustrated in FIG. 3 and FIG. 4

FIG. 3 illustrates operational sequence 300 in accordance with an embodiment. Operational sequence 300a is representative of an operational sequence of a data storage system and may be considered with regard to the elements and techniques of each of operational environment 100a of FIG. 1A, environment 100b of FIG. 1B, and method 200 of FIG. 2.

Storage controller 110 and storage controller 120 are each configured to give lease locks to clients in response to receiving I/O requests from the clients. The lease locks give clients exclusive access to a file or portion of a file in storage aggregate 130. When a storage controller give a lease lock to a client, other storage controllers are configured to refrain from giving the same lease lock to other clients and from executing I/O requests with respect to the file or portion of a file associated with the lease lock. The access control that lease locks provide prevents conflicts and helps to maintain data consistency for the data contained in the corresponding region of storage aggregate 130. Storage controller 110 and storage controller 120 are each configured to persist lease lock data (e.g., lease lock data 140) to storage aggregate 130 after having obtained a lock. In some cases, the lease lock data is persisted to a partition of storage aggregate 130 (e.g., storage 131 of FIG. 1) that is reserved for metadata of the data storage system.

Storage controller 110 receives an I/O request from client 101 corresponding to File X. In some embodiments, the I/O request is received at storage controller 110 via a connection manager, such as connection manager 105 of FIG. 1. Storage controller 110 receives the I/O requests and gives client 101 a lease lock corresponding to the file or portion of a file associated with the I/O request (i.e., File X).

Storage controller 110 then persists lease lock data to storage aggregate 130. The lease lock data reflects that storage controller 110 held the lease lock for File X on behalf of client 101. In some cases, storage controller 110 persists lease lock data to storage aggregate 130 on a per-lock basis, while in other embodiments storage controller 110 may batch lease lock data for a number of locks and persist the batch to storage aggregate 130.

Storage controller 110 then fails and a failover process begins. In some embodiments, the failover includes a LIF migration. Storage controller 120 detects the failure of storage controller 110 and begins the failover process in which storage controller 120 takes the place of the failed storage controller 110. In some cases, the LIF migration may be the result of some other event that the failure of storage controller 110, such as a handover event associated with maintenance or upgrades.

Storage controller 120, which now assumes the tasks and resources managed by storage controller 110, acquires a recent version of the lease lock data from storage aggregate 130. In some embodiments, storage controller 120 retrieves a recent version of the lease lock data after receiving an I/O request. In either case, storage controller 120 receives an I/O request and reads the lease lock data to determine how to proceed. The I/O requests was received from client 101 and is associated with File X. Storage controller 120 determines from the lease lock data that, at the time storage controller 110 failed, storage controller 110 held a lock associated with File X on behalf of client 101. Because the I/O request received at the second storage controller is for File X and was received from client 101, storage controller 120 can immediately proceed with the I/O request because the risk of collision with another user is effectively eliminated. In another scenario, a different client (e.g., client 105) requests the lock corresponding to file X. In some embodiments, storage controller 120 may be configured to allow the different client to obtain the lease lock simply because the failure of storage controller 110 has reduced the likelihood of a collision. In some other embodiments, storage controller 120 may be configured refrain from immediately executing the request on behalf of the different client in order to allow the original client (client 101) to reclaim the lock.

The risk of collision is effectively eliminated here because storage controller 120 has confirmed, via the persisted lease lock data obtained from storage aggregate 130, that the lock was previously held by storage controller 110 on behalf of client 101. As a result, storage controller 120 can safely process the I/O on behalf of client 101 without actually obtaining the lock because the previous holder of the lock is no longer active due to failure.

FIG. 4 illustrates further operational sequence 400 in accordance with an embodiment, hereinafter referred to as operational sequence 400. Operational sequence 400 is representative of an operational sequence of a data storage system and may be considered with regard to the elements and techniques of each of operational environment 100a of FIG. 1A, environment 100b of FIG. 1B, and method 200 of FIG. 2.

Storage controller 110 receives an I/O request from client 101 corresponding to File X. In some embodiments, the I/O request is received at storage controller 110 via a connection manager, such as connection manager 105 of FIG. 1. Storage controller 110 receives the I/O requests and obtains a lease lock on behalf of client 101 that corresponds to File X.

Storage controller 110 then persists lease lock data to storage aggregate 130. The lease lock data reflects that storage controller 110 holds the lease lock for File X on behalf of client 101. In some cases, storage controller 110 persists lease lock data to storage aggregate 130 on a per-lock basis, while in other embodiments storage controller 110 may batch lease lock data for a number of locks and persist the batch to storage aggregate 130.

Storage controller 110 then fails and a failover process begins. In some embodiments, the failover includes a LIF migration. Storage controller 120 detects the failure of storage controller 110 and begins the failover process in which storage controller 120 takes the place of the failed storage controller 110. In some cases, the LIF migration may be the result of some other event that the failure of storage controller 110, such as a handover event associated with maintenance procedures or upgrades.

Storage controller 120, which now assumes the tasks and resources managed by storage controller 110, acquires a recent version of the lease lock data from storage aggregate 130. In some embodiments, storage controller 120 retrieves a recent version of the lease lock data after receiving an I/O request. In either case, storage controller 120 receives an I/O request and reads the lease lock data to determine how to proceed.

The I/O requests was received from client 103 and is associated with File Y. Storage controller 120 determines from the lease lock data that, at the time storage controller 110 failed, storage controller 110 held a lock associated with File X on behalf of client 101. However, the I/O request received at storage controller 120 was received from client 103 and is for File Y. Unlike in FIG. 3, storage controller 120 cannot immediately proceed with the I/O request because the relevant lock for the I/O request was not held by the failed storage controller 110. Instead, storage controller 120 must determine if the lease lock corresponding to File Y is available. In some embodiments, storage controller 120 queries a distributed lock service implemented on storage controller 120 to determine if the lease lock for File Y is available. Where the lock is available, storage controller 120 acquires the lock on behalf of client 103 and executes the I/O request with respect to File Y. Where the lock is not available, storage controller 120 must wait to execute the I/O request for File Y.

In the example shown in FIG. 4, the lease lock for File Y is available. In response, storage controller 120 obtains the lock on behalf of client 103 and executes the I/O request with regard to File Y at storage aggregate 130. Beneficially, this allows client 105 to execute the I/O request with respect to File Y without waiting for the grace period to end as a result of knowing exactly which locks the now failed storage controller 110 held based on the information contained in the lease lock data.

FIG. 5 illustrates computing device 505, which is representative of any system or collection of systems in which the various applications, processes, services, and scenarios disclosed herein may be implemented. Examples of computing apparatus illustrated by computing device 505 include, but are not limited to server computers, web servers, cloud computing platforms, controllers, and data center equipment, as well as any other type of physical or virtual server machine, container, and any variation or combination thereof. In some examples, computing device 505 may also be representative of desktop and laptop computers, tablet computers, and the like.

In some cases, computing device 505 is representative of a storage controller in a data storage system. In such cases, storage operating system 535 is representative of a generic example of an operating system of a storage controller. In one example, storage operating system 535 may include several modules, or “layers” executed by one or both of a network module and a storage module. These layers include a file system manager 540 that keeps track of a hierarchical structure of the stored data and manages read/write operation, i.e. executes read/write operation on storage in response to I/O requests, as described above in detail. In some cases, file system manager 540 interfaces with a failover module during a failover operation to enable access to storage managed by a failed storage system node via a partner storage system node.

Storage operating system 535 may also include a protocol layer 542 and an associated network access layer 546, to allow storage nodes to communicate over a network with other systems, such as client 101 and client 103, each of FIG. 1. Protocol layer 542 may implement one or more of various higher-level network protocols, such as SAN (e.g. iSCSI) (542a), CIFS (542b), NFS (542c), Hypertext Transfer Protocol (HTTP) (not shown), TCP/IP (not shown) and others (542d).

Network access layer 546 may include one or more drivers, which implement one or more lower-level protocols to communicate over the network, such as Ethernet. Interactions between host systems and mass storage devices are illustrated schematically as a path, which illustrates the flow of data through storage operating system 535.

The storage operating system 535 may also include a storage access layer 544 and an associated storage driver layer 548 to allow a storage controller (e.g., storage controller 110 of FIG. 1) to communicate with a storage device. The storage access layer 544 may implement a higher-level storage protocol, such as RAID (544a), a S3 layer 544b to access a capacity tier for object-based storage (not shown), and other layers 544c. The storage driver layer 548 may implement a lower-level storage device access protocol, such as Fibre Channel or SCSI. The storage driver layer 548 may maintain various data structures (not shown) for storing information regarding storage volume, aggregate and various storage devices.

As used herein, the term “storage operating system” generally refers to the computer-executable code operable on a computer to perform a storage function that manages data access and may, in the case of a storage system node, implement data access semantics of a general-purpose operating system. The storage operating system can also be implemented as a microkernel, an application program operating over a general-purpose operating system, such as UNIX® or Windows®, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly attached to a client or host computer. The term “storage system” should therefore be taken broadly to include such arrangements in addition to any subsystems configured to perform a storage function and associated with other equipment or systems. It should be noted that while this description is written in terms of a write any-where file system, the teachings of the present disclosure may be utilized with any suitable file system, including a write in place file system.

Computing device 505 may be implemented as a single apparatus, system, or device or may be implemented in a distributed manner as multiple apparatuses, systems, or devices. Computing device 505 includes, but is not limited to, processing system 525, storage system 510, software 515, communication interface system 520, and user interface system 530. Processing system 525 is operatively coupled with storage system 510, communication interface system 520, and user interface system 530.

Processing system 525 loads and executes software 515 from storage system 510. Software 515 includes and implements controller operating system 535, which is representative of the processes discussed with respect to the preceding Figures. When executed by processing system 525, software 515 directs processing system 525 to operate as described herein for at least the various processes, operational scenarios, and sequences discussed in the foregoing implementations. Computing device 505 may optionally include additional devices, features, or functionality not discussed for purposes of brevity.

Referring still to FIG. 5, processing system 525 may include a micro-processor and other circuitry that retrieves and executes software 515 from storage system 510. Processing system 525 may be implemented within a single processing device but may also be distributed across multiple processing devices or sub-systems that cooperate in executing program instructions. Examples of processing system 525 include general purpose central processing units, microcontroller units, graphical processing units, application specific processors, integrated circuits, application specific integrated circuits, and logic devices, as well as any other type of processing device, combinations, or variations thereof.

Storage system 510 may comprise any computer readable storage media readable by processing system 525 and capable of storing software 515. Storage system 510 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 510 may be implemented as a single storage device but may also be implemented across multiple storage devices or sub-systems co-located or distributed relative to each other. Storage system 510 may comprise additional elements, such as a controller, capable of communicating with processing system 525 or possibly other systems.

Software 515 (including controller operating system 535) may be implemented in program instructions and among other functions may, when executed by processing system 525, direct processing system 525 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 515 may include additional processes, programs, or components, such as operating system software, virtualization software, or other application software. Software 515 may also comprise firmware or some other form of machine-readable processing instructions executable by processing system 525.

In general, software 515, when loaded into processing system 525 and executed, transforms a suitable apparatus, system, or device (of which computing device 505 is representative) overall from a general-purpose computing system into a special-purpose computing system customized to support lock processes as described herein. Indeed, encoding software 515 on storage system 510 may transform the physical structure of storage system 510. The specific transformation of the physical structure may depend on various factors in different implementations of this description. Examples of such factors may include, but are not limited to, the technology used to implement the storage media of storage system 510 and whether the computer-storage media are characterized as primary or secondary storage, as well as other factors.

For example, if the computer readable storage media are implemented as semiconductor-based memory, software 515 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 520 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 505 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

1. A method, comprising:
by a first storage controller in a data storage system, persisting lease lock data to a storage aggregate in the data storage system;
by a second storage controller in the data storage system, and in response to a failover of the first storage controller to the second storage controller, obtaining the lease lock data from the storage aggregate;
by the second storage controller, receiving an I/O request from a client, wherein the I/O request is associated with at least a portion of a file in the storage aggregate;
determining, based on the lease lock data, that the first storage controller had not given a lease lock to any other client with respect to at least the portion of the file; and
responsively executing the I/O request.

2. The method of claim 1, wherein:
the failover comprises a migration of a logical interface from the first storage controller to the second storage controller;
clients connect to the first storage controller and the second storage controller via the logical interface; and
receiving the I/O request by the second storage controller comprises receiving the I/O request by the second storage controller via the logical interface.

3. The method of claim 1, further comprising:
by the second storage controller, receiving a lease lock request from a second client via a logical interface;
determining, based on the lease lock data, that the first storage controller had given a second lease lock to another client with respect to at least a portion of a file associated with an I/O request from the second client; and
responsively rejecting the lease lock request from the second client.

4. The method of claim 3, wherein the method further comprises:
in response to rejecting the lease lock request from the second client, attempting a subsequent lease lock request for the I/O request from the second client, wherein the subsequent lease lock request is made at a time when the second lease lock can be given to the second client.

5. The method of claim 1, wherein determining that the first storage controller had not given the lease lock to any other client with respect to at least the portion of the file based on the lease lock data comprises searching the lease lock data for an indication that the first storage controller had not given the lease lock to any other client with respect to at least the portion of the file.

6. The method of claim 1, wherein:
storage controllers of the data storage system provide network file system (NFS) to clients, wherein the clients include the client; and
the lease lock comprises an NFS lock.

7. The method of claim 6, wherein the NFS lock comprises a temporary, renewable lock on at least the portion of the file.

8. The method of claim 1, wherein persisting the lease lock data to the storage aggregate comprises persisting operational metadata of the first storage controller to a partition of the storage aggregate, wherein the partition is reserved for storing metadata.

9. A storage controller of a data storage system, comprising:
one or more memory devices;
one or more processors operatively coupled with the one or more memory devices; and
program instructions stored on the one or more memory devices that, when read and executed by
the one or more processors, direct the storage controller to at least:
in response to a migration of a logical interface from a partner storage controller of the data storage system to the storage controller, obtain lease lock data from a storage aggregate, wherein the partner storage controller persisted the lease lock data to the storage aggregate before the migration;
receive an I/O request from a client, wherein the I/O request is associated with at least a portion of a file in the storage aggregate;
determine, based on the lease lock data, that the partner storage controller had not given a lease lock to any other client with respect to at least the portion of the file; and
responsively execute the I/O request.

10. The storage controller of claim 9, wherein:
the migration of the logical interface from the partner storage controller to the storage controller is associated with a failover from the partner storage controller to the storage controller;
clients connect to the partner storage controller and the storage controller via the logical interface; and
the program instructions directing the storage controller to receive the I/O request further comprise instructions that, when executed, direct the storage controller to receive the I/O request via the logical interface.

11. The storage controller of claim 9, wherein the program instructions further comprise instructions that, when executed, direct the storage controller to:
receive a lease lock request from a second client via the logical interface;
determine, based on the lease lock data, that the partner storage controller had given a second lease lock to another client with respect to at least a portion of a file associated with an I/O request from the second client; and
reject the lease lock request from the second client.

12. The storage controller of claim 11, wherein the program instructions further comprise instructions that, when executed, direct the storage controller to:
in response to executing the program instructions directing the storage controller, reject the lease lock request from the second client, and
attempt a subsequent lease lock request for the I/O request from the second client, wherein the subsequent lease lock request is made at a time when the second lease lock can be given to the second client.

13. The storage controller of claim 9, wherein the program instructions directing the storage controller to determine that the partner storage controller had not given the lease lock to any other client further comprises instructions that, when executed, direct the storage controller to search the lease lock data for an indication that the partner storage controller had not given the lease lock to any other client with respect to at least the portion of the file.

14. The storage controller of claim 9, wherein logical interface migration is associated with a handover process.

15. The storage controller of claim 14, wherein:
the handover process comprises a lock state process for recording lock state information prior to the logical interface migration, and
the lock state process is not complete at the time of the logical interface migration.

16. A data storage system, comprising:
a storage aggregate;
a first storage controller configured to persist lease lock data to the storage aggregate; and
a second storage controller configured to:
in response to a failover of the first storage controller to the second storage controller, obtain the lease lock data from the storage aggregate; and
immediately process incoming I/O requests from a client when the lease lock data indicates that the client owns a lock on the at least a portion of a file or when the lease lock data indicates that there is no current lock on the file.

17. The data storage system of claim 16, wherein:
the failover comprises a migration of a logical interface from the first storage controller to the storage second controller;
clients connect to the first storage controller and the second storage controller via the logical interface; and
to receive the I/O request, the second storage controller is further configured to receive the I/O request via the logical interface.

18. The data storage system of claim 16, wherein the second storage controller is further configured to:
receive a lease lock request from a second client via a logical interface;
determine, based on the lease lock data, that the first storage controller had given a second lease lock to another client with respect to at least a portion of a file associated with an I/O request from the second client; and
responsively reject the lease lock request from the second client.

19. The data storage system of claim 16, wherein:
storage controllers of the data storage system provide a network file system (NFS) to clients, wherein the clients include the client; and
the lease lock comprises an NFS lock comprising a temporary, renewable lock on at least the portion of the file.

20. The data storage system of claim 16, wherein:
to persist the lease lock data to the storage aggregate, the first storage controller is further configured to persist operational metadata of the first storage controller to a partition of the storage aggregate; and
wherein the partition is reserved for storing metadata.
